(19) United States
(12) Patent Application Publication
(10) Pub. No.: US 2026/0167537 A1
(43) Pub. Date: Jun. 18, 2026

(54) CLOSED WATER CIRCUIT FOR COOLING HOMOGENIZATION SYSTEMS, WITH THE USE OF ADVANCED OXIDATION

(71) Applicants: Gustavo BERMUDEZ GUERRERO, TLALNEPANTLA DE BAZ (MX); Guillermo VÁZQUEZ DE ANDA, HUIXQUILUCAN DE DEGOLLADO (MX); Raquel BERMUDEZ LARA, TLALNEPANTLA DE BAZ (MX); Guillermo VÁZQUEZ GÓMEZ, HUIXQUILUCAN DE DEGOLLADO (MX)

(72) Inventors: Gustavo BERMUDEZ GUERRERO, TLALNEPANTLA DE BAZ (MX); Guillermo VÁZQUEZ DE ANDA, HUIXQUILUCAN DE DEGOLLADO (MX); Raquel BERMUDEZ LARA, TLALNEPANTLA DE BAZ (MX); Guillermo VÁZQUEZ GÓMEZ, HUIXQUILUCAN DE DEGOLLADO (MX)

(21) Appl. No.: 19/293,972

(22) Filed: Aug. 7, 2025

(30) Foreign Application Priority Data
Dec. 18, 2024 (MX) A/2024/016054

(51) Int. Cl. C02F 1/72; A23B 2/10; C02F 1/00; C02F 1/32; C02F 101/30; C02F 103/02

(52) U.S. Cl. CPC C02F 1/722; A23B 2/10; C02F 1/001; C02F 1/32; C02F 2101/30; C02F 2103/023; C02F 2209/11; C02F 2303/04; C02F 2303/08; C02F 2305/023

(57) ABSTRACT

A closed water circuit for cooling homogenizing systems is disclosed. The closed water circuit uses advanced oxidation for disinfection and elimination of all types of bacterium's, as well as the oxidation of organic matter. The closed water circuit incorporates a closed circuit homogenizer cooling system, an advanced oxidation system and a filtering system. The water used for cooling the homogenizers within the closed circuit uses osmosed water, demineralized water, distilled water, bi-distilled or tri-distilled water, which allows leak detection. The closed circuit arrangement allows isolation of the leaking homogenizer(s) and avoids contamination of the water of the closed circuit.

### FIELD OF THE INVENTION

The present invention discloses a closed water circuit for cooling homogenizing systems, with the use of advanced oxidation to disinfect and eliminate all types of bacterium or organic matter. The closed water circuit incorporates a cooling system for closed-cycle homogenizers, an advanced oxidation system and a filtering system. The water used for cooling the homogenizers within the closed circuit uses osmosed water, demineralized water, distilled water, bi-distilled or tri-distilled water, together with turbidimeters that allow detecting product leaks that contaminate the water of the closed cooling circuit of a homogenizer, isolating the homogenizer or homogenizers that present leaks, and avoiding the contamination of the water of the closed circuit, using for this purpose a closed cycle system, an advanced oxidation system and a filtering system.

Such a system includes the use of osmosed water, demineralized water, distilled water, bi-distilled or tri-distilled water, which guarantee the reduction of dirt and the formation of incrustations and corrosion in the areas in contact with the system water.

### OBJECT OF THE INVENTION

An object of the closed circuit for cooling homogenizers is to use osmosed water, demineralized water, distilled water, bi-distilled or tri-distilled water in a closed circuit that allows the reduction of dirt and the formation of incrustations and corrosion in the areas in contact with the system water.

Another object of the closed circuit for cooling homogenizers is that it incorporates turbidity meters to detect contamination of the water within the closed circuit quickly identifying faults and leaks in the homogenizers.

Another object of the invention is that the water is not discarded, allowing its cyclic reuse.

Another objective is to eliminate dirt, incrustation and corrosion in areas in contact with water, improving the life of seals, joints and components and consequently reducing maintenance costs and production costs.

Another objective is to eliminate dirt, incrustation and corrosion in areas in contact with water through a filtering system.

Additionally, another objective is to support maintenance scheduling by measuring turbidity in case of product leakage into the water circuit.

Finally, the main objective of the present invention is to provide a sanitary system that prevents and eliminates all types of bacterium's or organic matter from the homogenizers through the use of measuring systems (turbidimeters) in combination with an advanced oxidation process.

### BACKGROUND OF THE INVENTION

Japan patent application JP2000295978A “Liquid Food Sterilizer” solves the problem of efficiently sterilizing a beverage, without affecting the organoleptic properties (odor, taste) and nutritional value that is lost when using temperature sterilization methods, and proposes as a solution repeated rapid pressurization and depressurization, where the beverage is sterilized by holding the beverage at a temperature of 40-80 degrees ° C. and subjecting it to repeated processes of rapid pressurization at 1,000-2,000 kg/cm² and rapid depressurization, at a pH of 5.0, using a pressure homogenizer.

Patent application US2008152775A1 “Inactivation of food spoilage and pathogenic microorganisms by high dynamic pressure” refers to a process using high dynamic pressure of 1 to 5 Kbar with at least one recirculation as required, wherein the process is carried out at temperature between 4 to 55° C., and comprises the steps of: (a) pressurizing the liquid milk product in a continuously pressurizing circulating system comprising a dynamic high pressure homogenizer (DHP); (b) subjecting the liquid milk product of step a) at least once and up to five times to a mechanism selected from the group consisting of pressure drop, shear stress, cavitation and pinching in said dynamic high pressure homogenizer (DHP) at a temperature which does not allow denaturation of said liquid milk food product; and c) collecting the liquid milk product from step b), whereby said dynamic high pressure homogenizer (DHP) reduces the number of viable microorganisms in said liquid milk food product.

European patent application EP2505083A1 “Continuous process for the sterilization of fruit and vegetable juices by ultra-high pressure homogenization (UHPH)”, describes the stages of extraction of fruit and/or vegetable juice, storage of the juice at a temperature between 0° C. and 4° C., preheating at a temperature between 4° C. and 90° C., treatment of the juice by ultra-high pressure homogenization at a pressure between 200 MPa and 400 MPa, with or without retention, through an ultra-high pressure valve, instant cooling of the juice at a temperature between 4° C. and 20° C., storage in an aseptic tank at a temperature between 4° C. and 20° C., and aseptic packaging of the juice in an aseptic packaging system.

### DETAILED DESCRIPTION OF THE INVENTION

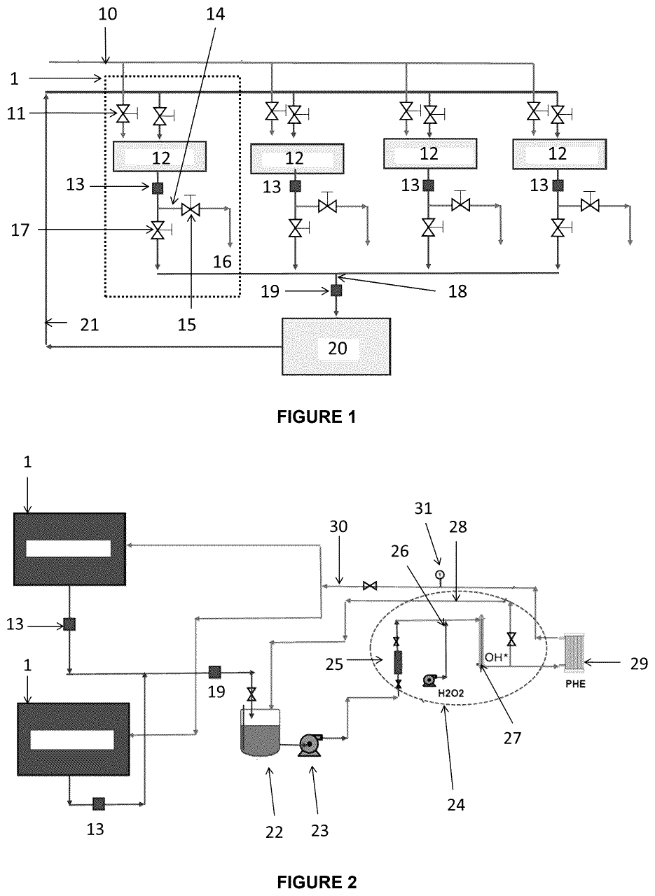

FIG. 1 shows a diagram of the closed circuit system for cooling homogenizers of the present invention.

FIG. 2 shows a diagram of the advanced oxidation process of the present invention.

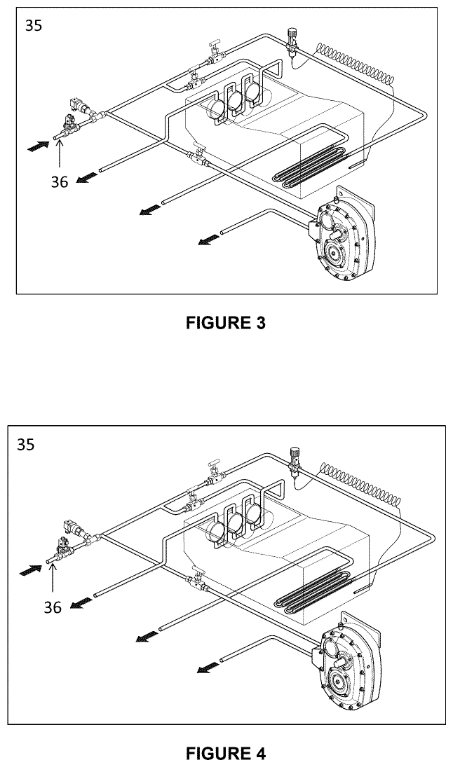

FIG. 3 shows a three-dimensional diagram of a basic homogenizer.

FIG. 4 shows a three-dimensional diagram of an aseptic homogenizer handling steam feed.

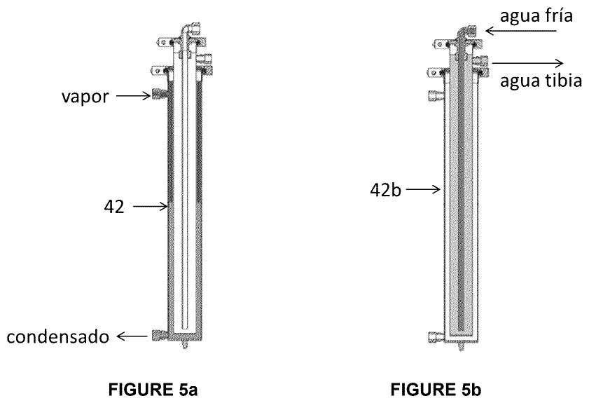

FIGS. 5a and 5b show the operation of the condenser in the equipment.

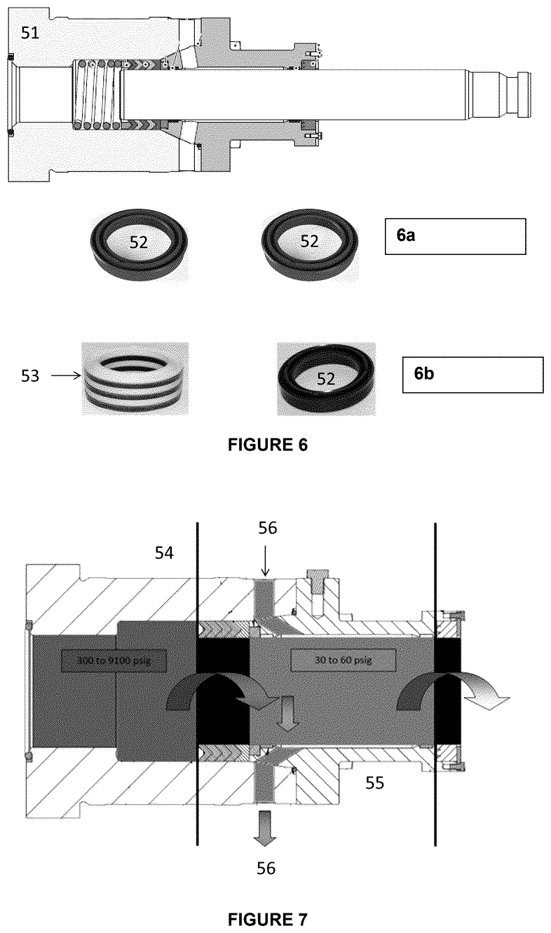

FIGS. 6a and 6b shows the seals in a homogenizing valve.

FIG. 7 shows a cross section of a homogenizing valve.

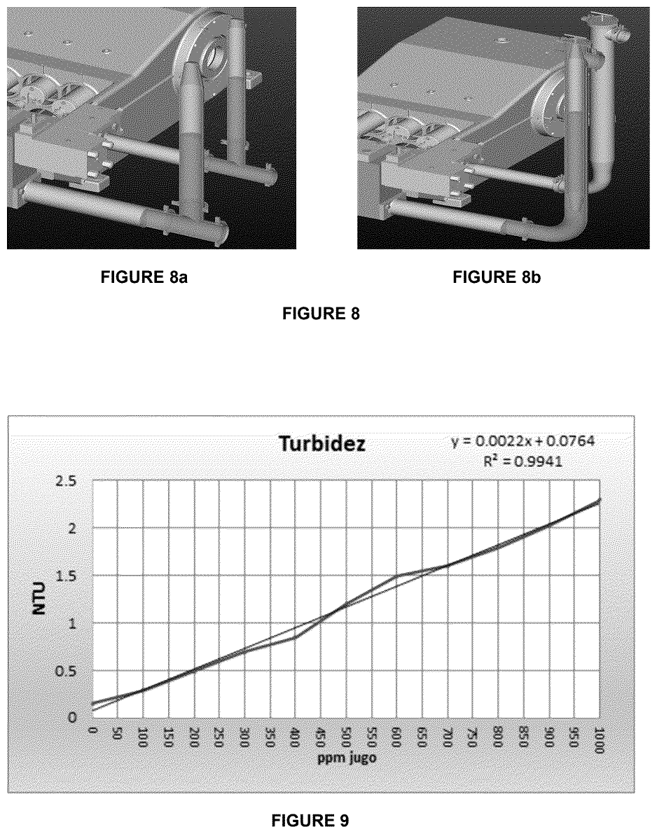

FIGS. 8a and 8b show the temperature dampers for a basic process and an aseptic process.

FIG. 9 illustrates a turbidity test issued by the turbidity meters, which detects the contamination of the water inside the closed cooling circuit for homogenizers.

### DESCRIPTION OF THE INVENTION

Homogenizers currently use cooling water in different sectors which is discharged to the drain once the cooling purpose has been fulfilled, which translates into high water consumption.

Homogenizers have a water cooling system that is disposed of; therefore, the invention comprises a closed system (using osmosed water, demineralized water, distilled water, bi-distilled or tri-distilled water) that allows detecting product leaks that contaminate the water of the closed circuit, allowing isolation of the homogenizer or homogenizers that present leaks, avoiding contamination of the water of the closed circuit.

The water quality used is pH 5 to 7, conductivity of 2 microsiemens/cm and 0.2 parts per million of silica.

The proposed invention prevents the water from being discarded by using a closed circuit that allows the cyclic reuse of water and turbidity meters that allow the detection of product leakage into the water circuit and contamination.

The main components of the closed circuit system in the homogenizers and the advanced oxidation process are turbidity meters, a plate or shell and tube cooler, filtration cartridges and a subsystem that incorporates an advanced oxidation process (AOP).

Any traces of product that may enter the equipment are removed through filtration and the advanced oxidation process. The use of 1 to 5 micron cartridge filters is recommended.

The advanced oxidation process makes use of food grade hydrogen peroxide together with the light generated by ultraviolet light lamps.

Turbidity measurement is performed on test tubes to determine turbidity, using the standardized 90° light scattering method according to ISO 7027/EN/27027. The measurement method is based on the Tyndall effect.

When the light beam is deflected from its original path caused by optically dense particles in the medium, it indicates the presence of solid particulate matter, i.e. the turbidity of the medium is determined by the amount of scattered light.

The transmitted infrared light beam is deflected by particles in the medium. Deflected beams are measured by stray light receivers that are located at an angle of 90° to the transmitted light. The stray light measurement is converted to frequency signals. The frequency signals are assigned to the corresponding turbidity units and solid matter concentrations that may appear on the screen.

The features of the turbidity meters of the present invention are listed below:
Measuring range: 0-10 NTU
Accuracy: +2% in the measuring point range of 0-10 NTU.
Resolution: 0.01 NTU in the measuring point range 0-10 NTU
Response time: 90% of the value in less than 60s.
Measurement method: Diffuse light at 90° · Operating temperature: 0 to 50° C.
Storage temperature:-10 to 60° C.
Maximum pressure: 4 bar
Material body: 316L stainless steel for pharmaceutical or food industry use, or PVC.
Viton and silicone O-rings
Optics: special glass with oleophobic treatment
Mechanical protection: IP68 sensor+cable
Mechanical connection: 1>>GAS (42 mm diameter)
Power supply: 12 to 24 VDC.
Consumption: 3 W max. electrical connection
Calibration. One point and 1 or 2 points for flakes.
Interface signal: 4-20 mA

On the other hand, the Advanced Oxidation Process (AOP) is a set of chemical treatments using food grade hydrogen peroxide in conjunction with an ultraviolet light lamp to promote the formation of hydroxyl radicals to remove organic matter, bacterium and viruses in water by oxidation with hydroxyl radicals —OH*, in the presence of ultraviolet light.

The Advanced Oxidation Process is effective and environmentally friendly for removing persistent organic contaminants, such as bacterium and viruses; it is also used for water disinfection.

The oxidation potential compared to the hydrogen electrode standard is:

| Oxidizer | Oxidation potential in mV |
|---|---|
| Fluorine | 3.0 |
| Radical OH | 2.8 |
| Ozone | 2.1 |
| Hydrogen peroxide | 1.8 |
| Potassium permanganate | 1.7 |
| Chlorine dioxide | 1.5 |
| Chlorine | 1.4 |

The instantaneous chemical reaction for OH* formation is:

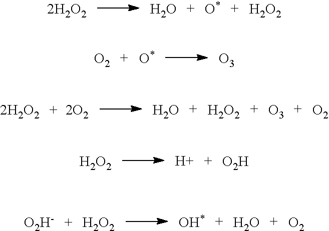

Where, at 25° C., the formation constant is equal to:

$$K = [ ( {H}^{+} ) ( O 2 {H}^{-} ) ] / ( H 2 O 2 ) = 2 \text{.24} \times {10}^{- 12}$$

and the free energy of formation is equal to −15.23 kcal/mol

Because the OH-radical is one of the most reactive radicals, it can interact with the nitrogenous bases of nucleic acids (DNA and RNA) and alter the genetic information of cells or stimulate lipid peroxidation, where OH* attacks polyunsaturated fatty acids, turning them into oxidants.

A single OH* radical can transform hundreds of fatty acid molecules into hydroperoxides, which upon decomposition produce aldehydes, real poisons for cell membranes.

According to FIG. 1, the homogenizing equipment is composed of several homogenizing units (1), where for each homogenizing unit, the water is fed through a pipe (10) to a valve (11) that controls the flow to a homogenizer (12), which at the outlet has a turbidity meter (13) to detect contamination of the service water coming from the product and a bypass (14) with a second valve (15) to send the water to a drain (16) in case of contamination. After the bypass (14), the water flow is controlled by a third valve (17) and led to a central pipe (18) that collects the water from one or several homogenization units (1) and passes it through another turbidity meter (19), where the turbidity is determined in the homogenization units and from there it is passed to the closed cycle homogenizer (20). If the water does not have the required turbidity level to guarantee disinfection, it is discarded; otherwise, the water is returned to the homogenization units (1) through a pipe that carries osmosed water, demineralized water, distilled water, bi-distilled water or tri-distilled water (21).

Continuing with FIG. 2, the water that meets the desired turbidity requirement is stored in a collecting tank (22) from where with a pump (23) it is pumped to the advanced oxidation system (24) where the advanced oxidation process is performed. The water is fed to a cartridge filter (25) where the cartridge preferably has from 1 to 5 microns and subsequently is mixed in line (26) with hydrogen peroxide, to subsequently pass through a UV light source (27), with the consequent release of OH* radicals; and subsequently, by means of a second bypass (28) a portion of the flow is returned to the collecting tank (22) and the other portion is sent to a PHE plate exchanger equipment (25) and subsequently sent back to the homogenizers (6) through a return pipe (30) which has a thermometer (31) for temperature measurement and control.

Within the food industry there are two levels of sanitation by homogenization, the basic one that operates at a temperature of 85° C. and the aseptic one that operates at a temperature of 140.5° C., which adds a steam circuit, valves and condenser to the equipment. The closed water cycle used in the homogenizers (1) allows reusing water and reducing costs.

The basic homogenizers are referred to upstream operation, before the product receives a thermal treatment. Aseptic homogenizers, on the other hand, are referred to downstream operation, once the product has been pasteurized and maximum sterilization is maintained.

The benefits of placing a homogenizer downstream is the denaturation of proteins derived from the heat treatment that are broken upstream and better product quality. Against the benefits, it is a more expensive system to operate, which requires higher consumption of utilities.

FIG. 3 shows a basic homogenizer (35) with only one water feed circuit (36).

FIG. 4 shows an aseptic homogenizer (40) which, unlike the basic homogenizer (35), incorporates a steam line (41) and a condenser (42) so that the steam barrier can function as a lubricant for the piston.

FIG. 5a shows a condenser (42) operating with steam, while FIG. 5b shows the condenser (42b) operating only with water as exchange medium.

FIG. 6a shows the annular seals (52) used in the homogenizing valve (51) when the operating temperature is up to 85° C., being the annular seals (52) with double perimeter wall (internal and external) and an internal rim in the middle of both walls and when the temperature is above 85° C. and up to 140. 5° C. (FIG. 6b), a first reinforced triple annular seal (53) is used to work at that temperature and a second seal (52) with double perimeter wall (internal and external) and an internal edge in the middle of both walls.

All pumps located in the sterile zone should have protective seals with a vapor barrier to ensure zero risk of contamination.

On the other hand, piston seals need liquid on both sides for better lubrication.

FIG. 7 shows the product in a first section (54) of a valve, where the pressure for the product is from 21.09 Kgf/cm² to 639.79 Kgf/cm² (300 to 9100 psig), while in the second section (55) of the valve, the service water has a pressure of 2.10 to 4.22 Kgf/cm² at the inlet and is discharged at atmospheric pressure at the outlet, including in the second section (55) the cooling water passage (56).

The dampers in FIG. 8, for basic sanitary level (8a) have been designed as simple vertical tubes, extending by far their effectiveness for cleaning in place (Cleaning in place); while for aseptic sanitary level (SIP: Sterilization in place) shown in FIG. 8b, they have a nested design, i.e., one tube inside another.

1. A closed water circuit for cooling homogenizing systems, using advanced oxidation to disinfect and eliminate all types of bacterium or oxidize organic matter, comprising: a closed circuit homogenizer cooling system, an advanced oxidation system, and a filtering system.

2. The closed water circuit for cooling homogenizing systems of claim 1, further including turbidity meters for water quality control in the closed circuit homogenizer cooling system.

3. The closed water circuit for cooling homogenizing systems of claim 2, wherein the turbidity meters use a 90-degree beam scattering turbidity method.

4. The closed water circuit for cooling homogenizing systems of claim 1, wherein the closed water circuit uses an advanced oxidation system to reduce turbidity caused by organic matter and disinfection of water within the closed circuit homogenizer cooling system.

5. The closed water circuit for cooling homogenizing systems of claim 1, further including a system of filters to remove suspended solids from the water, and the incrustations and corrosion from the areas in contact with water within the closed circuit homogenizer cooling system.

6. A high pressure homogenizer cooling process, comprising: incorporating an advanced oxidation subsystem for the water used in cooling and a filtration system.
